(19) United States
(12) Patent Application Publication
(10) Pub. No.: US 2024/0346119 A1
(43) Pub. Date: Oct. 17, 2024

(54) DIGITAL APPROVAL OF DOCUMENTS USING VERBAL CONSENT AUDIO FILES

(71) Applicant: BANK OF AMERICA CORPORATION, Charlotte, NC (US)

(72) Inventors: Michael Betsko, Chandler, AZ (US); Ryan Scott Heller, Middletown, DE (US); Vince A. Holt, Savannah, TX (US)

(73) Assignee: BANK OF AMERICA CORPORATION, Charlotte, NC (US)

(21) Appl. No.: 18/135,307

(22) Filed: Apr. 17, 2023

(51) Int. Cl. G06F 21/32; G06Q 50/18

(52) U.S. Cl. CPC G06F 21/32; G06Q 50/18

(57) ABSTRACT

Verbal consent is captured from a user as valid electronic document approval. In this regard, verbal consent provided by a user is captured in an audio file, either concurrent with document presentation or prerecorded/preregistered, and, in response to the user providing an input that approves the electronic document's content, the verbal consent audio file is logically attached to the document to serve as a valid “signature” (i.e., approval/acceptance of the documents content). The electronic document and attached verbal consent audio file, along with a timestamp, is stored in a data repository, such that the verbal consent audio file can be used for evidentiary purposes in subsequently proving the validity of the user's document content approval.

### FIELD OF THE INVENTION

The present invention is generally directed to electronic document approval and, more specifically, using verbal consent captured in an audio file as an approval mechanism for electronic documents.

### BACKGROUND

Today, electronic signatures, commonly referred to as e-signatures are used as an efficient and secure means of signing (i.e., “approving”) digital/electronic documents. E-signatures are used as a replacement for physical signatures, commonly referred to as wet signatures, in many instances, including sales contracts, offer letters, account openings, invoices and the like. Unlike wet signatures, e-signatures are generally highly efficient, mobile-friendly and offer protection via digital security tools. When a user intends to sign or otherwise approve a document, the e-signature is attached or logically associated with the corresponding document and serves as a valid electronic signature.

However, in most instances e-signing of a document requires the user navigate to signature entry fields and provide their preconfigured mark that is associated with their respective e-signature. The ability to perform such functions may be difficult if the user has temporary or permanent disabilities, e.g., vision impairment, typing impairment, reading disorder or the like.

Therefore, a need exists to develop alternate systems, methods, computer program products and the like for approving (i.e., “signing”) digital/electronic documents. The desired system, methods, computer program products and the like should offer the same or higher level of efficiency and security as is afforded by conventional e-signatures, while also accommodating users who may be unable to perform, or find difficulty in performing, the e-signature process.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, apparatus, methods and/or the like that leverage the use verbal consent as valid digital/electronic document approval. In this regard, verbal consent provided by a user is captured in an audio file and the verbal consent audio file is logically attached to the document to serve as a valid signature (i.e., approval/acceptance of the documents content). The verbal consent audio file, along with a timestamp, is stored in conjunction with the document and can subsequently be used for evidentiary purposes in proving the validity of the user's approval.

In specific embodiments of the invention, the user's verbal consent is recorded concurrent with the presentation of the document requiring approval(s). In such embodiments of the invention, each document has a unique verbal consent audio file logically attached thereto to form the digital signature/approval. In other specific embodiments of the invention, the user's verbal consent is a pre-recorded generic verbal consent that is attached to the document requiring approval once the user provides an input, verbal or otherwise, that indicates their approval of the document's contents.

In further specific embodiments of the invention, the user's voice may be verified at the time of authentication via voice recognition (i.e., comparing a user's voice input to a preregistered user voice print) and/or at the time the verbal consent is captured and recorded (i.e., comparing the user's voice in the verbal consent to a preregistered user voice print).

A system for digital signing/approval of electronic documents defines first embodiments of the invention. The system includes a computing platform having a memory and at one or more first processor devices in communication with the memory. The memory stores a voice consent document approval application that is executable by at least one of the one or more first processor devices.

In response to authenticating an identity of a user, the voice consent document approval application is configured to present the user with an electronic document having one or more signature requirements for the user to approve contents of the electronic document. In response to presenting the document, voice consent document approval application is configured to receive at least one input from the user that is configured to approve the contents of the electronic document, and, in response to receiving the input, logically attach the verbal approval audio file to the electronic document and provide a timestamp that indicates a date and a time of the logical attachment.

Additionally, the system includes a data repository that is configured to receive and store the electronic document with the logically attached verbal approval audio file and the timestamp.

In specific embodiments of the invention, the computing platform further comprises (i) an audio-receiving device in communication with at least one of the one or more first processor devices and (ii) an audio-recording mechanism in communication with the audio-receiving device and at least one of the one or more first processor devices. In such embodiments of the system, the voice consent document approval application is further configured to receive the input, which comprises verbal approval spoken by the user received by the audio-receiving device and recorded by the audio-recording mechanism to form the verbal approval audio file. In related embodiments of the invention, the voice consent document approval application is further configured to compare the recorded verbal approval to a prerecorded voice sample audio file associated with the user to confirm that the verbal approval was spoken by the user, and, in response to confirming that the verbal approval was spoken by the user, logically attach the verbal approval audio file to the electronic document and provide the timestamp that indicates the date and the time of the logical attachment.

In other specific embodiments of the system, the verbal approval audio file is a preregistered verbal approval audio file, in that, preregistration provides for verification that the user has spoken or authorized the verbal approval in the audio file.

In still further specific embodiments of the system, the memory of the computing platform further stores an authentication application that is executable by at least one of the one or more first processor devices. The authentication application is configured to receive and record a voice sample from the user and compare the received voice sample to a prerecorded voice sample audio file associated with the user to authenticate the identity of the user. In related embodiments of the system, the voice consent document approval application is further configured to receive the at least one non-verbal input from the user that is configured to approve the contents of the electronic document and logically attach a preregistered verbal approval audio file to the electronic document, in that, preregistration provides for verification that the user has spoken or authorized the verbal approval in the audio file.

In further specific embodiments of the system, the voice consent document approval application is further configured to (i) input a preregistered electronic signature associated with the user in one or more signature entry fields within the electronic document, in that, preregistration provides for verification that the electronic signature is associated with the user, and (ii) logically attach the preregistered electronic signature to the electronic document.

A computer-implemented method for digital approving of electronic documents, defines second embodiments of the invention. The method is executed by one or more processing devices. The method includes, in response to authenticating an identity of a user, presenting the user with an electronic document having one or more signature requirements for the user to approve contents of the electronic document. In response the presenting the electronic document, the method includes receiving at least one input from the user that is configured to approve the contents of the electronic document, and, in response to receiving the input(s), logically attaching the verbal approval audio file to the electronic document and providing a timestamp that indicates a date and a time of the logical attachment. Further, the method includes storing, in a data repository, the electronic document with the logically attached verbal approval audio file and the timestamp.

In specific embodiments of the computer-implemented method, receiving the at least one input further includes receiving the at least one input comprising a verbal approval spoken by the user, and the method further includes recording the verbal approval to form the verbal approval audio file. In related embodiments the computer-implemented method further includes comparing the recorded verbal approval to a prerecorded voice sample audio file associated with the user to confirm that the verbal approval was spoken by the user, and in response to confirming that the verbal approval was spoken by the user, logically attaching the verbal approval audio file to the electronic document and provide the timestamp that indicates the date and the time of the logical attachment.

In other specific embodiments of the computer-implemented method, logically attaching the verbal approval audio file to the electronic document further includes logically attaching a preregistered verbal approval audio file to the electronic document, in that, preregistration provides for verification that the user has spoken or authorized the verbal approval in the audio file.

In still further specific embodiments, the computer-implemented method includes receiving and recording a voice sample from the user and comparing the received voice sample to a prerecorded voice sample audio file associated with the user to authenticate the identity of the user. In related embodiments of the computer-implemented method, receiving the at least one input from the user that is configured to approve the contents of the electronic document includes receiving a non-verbal input and logically attaching further includes logically attaching a preregistered verbal approval audio file to the electronic document, in that, preregistration provides for verification that the user has spoken or authorized the verbal approval in the audio file.

Moreover, in other specific embodiments the computer-implemented method further includes inputting a preregistered electronic signature associated with the user in one or more signature entry fields within the electronic document, in that, preregistration provides for verification that the electronic signature is associated with the user, and logically attaching the preregistered electronic signature to the electronic document.

A computer program product including a non-transitory computer-readable medium defines third embodiments of the invention. The computer-readable medium includes a first set of codes for causing a computer processing device to, in response to authenticating an identity of a user, present the user with an electronic document having one or more signature requirements for the user to approve contents of the electronic documents. Additionally, the computer-readable medium includes a second set of codes for causing a computer processing device to receive at least one input from the user that is configured to approve the contents of the electronic document. Further, the computer-readable medium includes a third set of codes for causing a computer processing device logically attach the verbal approval audio file to the electronic document and providing a timestamp that indicates a date and a time of the logical attachment. In addition, the computer-readable medium includes a fourth set of codes to store, in a data repository, the electronic document with the logically attached verbal approval audio file and the timestamp.

In specific embodiments of the computer program product, the second set of codes are further configured to cause the computer processing device to receive the at least one input comprising a verbal approval spoken by the user, and the computer-readable medium further includes a fifth set of codes for causing a computer processing device to record the verbal approval to form the verbal approval audio file.

In other specific embodiments of the computer program product, the computer-readable medium further includes a fifth set of codes for causing a computer processing device to compare the recorded verbal approval to a prerecorded voice sample audio file associated with the user to confirm that the verbal approval was spoken by the user. In addition, the computer-readable medium includes a sixth set of codes for causing a computer processing device to, in response to confirming that the verbal approval was spoken by the user, logically attach the verbal approval audio file to the electronic document and provide the timestamp that indicates the date and the time of the logical attachment.

In further specific embodiments of the computer program product, the third set of codes are further configured to cause the computer processing device to logically attach a preregistered verbal approval audio file to the electronic document, wherein preregistration provides for verification that the user has spoken or authorized the verbal approval in the audio file.

In other specific embodiments of the computer program product the computer-readable medium further includes a fifth set of codes for causing a computer processing device to receive and record a voice sample from the user, and a sixth set of codes for causing a computer processing device to compare the received voice sample to a prerecorded voice sample audio file associated with the user to authenticate the identity of the user.

In still further specific embodiments of the computer program product, the second set of codes are further configured to cause the computing processing device to receive a non-verbal input to attach a preregistered verbal approval audio file to the electronic document, wherein preregistration provides for verification that the user has spoken or authorized the verbal approval in the audio file.

Thus, according to embodiments of the invention, which will be discussed in greater detail below, the present invention provides for verbal consent as valid digital/electronic document approval. In this regard, verbal consent provided by a user is captured in an audio file, either concurrent with document presentation or prerecorded/preregistered, and, in response to the user providing an input that approves the electronic document, the verbal consent audio file is logically attached to the document to serve as a valid signature (i.e., approval/acceptance of the documents content). The verbal consent audio file, along with a timestamp, is stored in conjunction with the document and can subsequently be used for evidentiary purposes in proving the validity of the user's approval.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a system for verbal approval of electronic documents, in accordance with embodiments of the present invention;

FIG. 2 is a flow diagram of a method for verbal approval of electronic documents, in accordance with embodiments of the present invention;

FIG. 3 is a schematic/block diagram of a system for verbal approval of electronic documents, in which the verbal approval is recorded concurrent with document presentation, in accordance with embodiments of the present invention;

FIG. 4 is a flow diagram of a method for verbal approval of electronic documents, in which the verbal approval is recorded concurrent with document presentation, in accordance with embodiments of the present invention;

FIG. 5 is a schematic/block diagram of a system for verbal approval of electronic documents, in which the verbal approval is recorded concurrent with document presentation and verified as being spoken by the user, in accordance with embodiments of the present invention;

FIG. 6 is a flow diagram of a method for verbal approval of electronic documents, in which the verbal approval is recorded concurrent with document presentation and verified as being spoken by the user, in accordance with embodiments of the present invention;

FIG. 7 is a schematic/block diagram of a system for verbal approval of electronic documents, in which the verbal approval is prerecorded/preregistered, in accordance with embodiments of the present invention;

FIG. 8 is a flow diagram of a method for verbal approval of electronic documents, in which the verbal approval is prerecorded/preregistered, in accordance with embodiments of the present invention;

FIG. 9 is a schematic/block diagram of a system for verbal approval of electronic documents, in which the user is authenticated via voice sample comparison to a prerecorded voice sample and the verbal approval is recorded concurrent with document presentation with the authentication serving as verification that the verbal approval came from the user, in accordance with embodiments of the present invention;

FIG. 10 is a flow diagram of a method for verbal approval of electronic documents, in which the user is authenticated via voice sample comparison to a prerecorded voice sample and the verbal approval is recorded concurrent with document presentation with the authentication serving as verification that the verbal approval came from the user, in accordance with embodiments of the present invention;

FIG. 11 is a schematic/block diagram of a system for verbal approval of electronic documents, in which the user is authenticated via voice sample comparison to a preregistered verbal approval audio file, which also serves as the verbal approval; in accordance with embodiments of the present invention;

FIG. 12 is a flow diagram of a method for verbal approval of electronic documents, in which the user is authenticated via voice sample comparison to a preregistered verbal approval audio file, which also serves as the verbal approval; in accordance with embodiments of the present invention; and

FIG. 13 is block/flow diagram of a methodology for third-party presentation of an electronic document requiring approval and subsequent storage of the approved document and attached verbal approval audio file; in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, systems, apparatus, and methods are described in detail below that leverage the use verbal consent as valid digital/electronic document approval. In this regard, verbal consent provided by a user is captured in an audio file and the verbal consent audio file is logically attached to the document to serve as a valid signature (i.e., approval/acceptance of the documents content). The verbal consent audio file, along with a timestamp, is stored in conjunction with the document and can subsequently be used for evidentiary purposes in proving the validity of the user's approval.

In specific embodiments of the invention, the user's verbal consent is recorded concurrent with the presentation of the document requiring approval(s). In such embodiments of the invention, each document has a unique verbal consent audio file logically attached thereto to form the digital signature/approval. In other specific embodiments of the invention, the user's verbal consent is a pre-recorded generic verbal consent that is attached to the document requiring approval once the user provides an input, verbal or otherwise, that indicates their approval of the document's contents.

In further specific embodiments of the invention, the user's voice may be verified at the time of authentication via voice recognition (i.e., comparing a user's voice input to a preregistered user voice print) and/or at the time the verbal consent is captured and recorded (i.e., comparing the user's voice in the verbal consent to a preregistered user voice print).

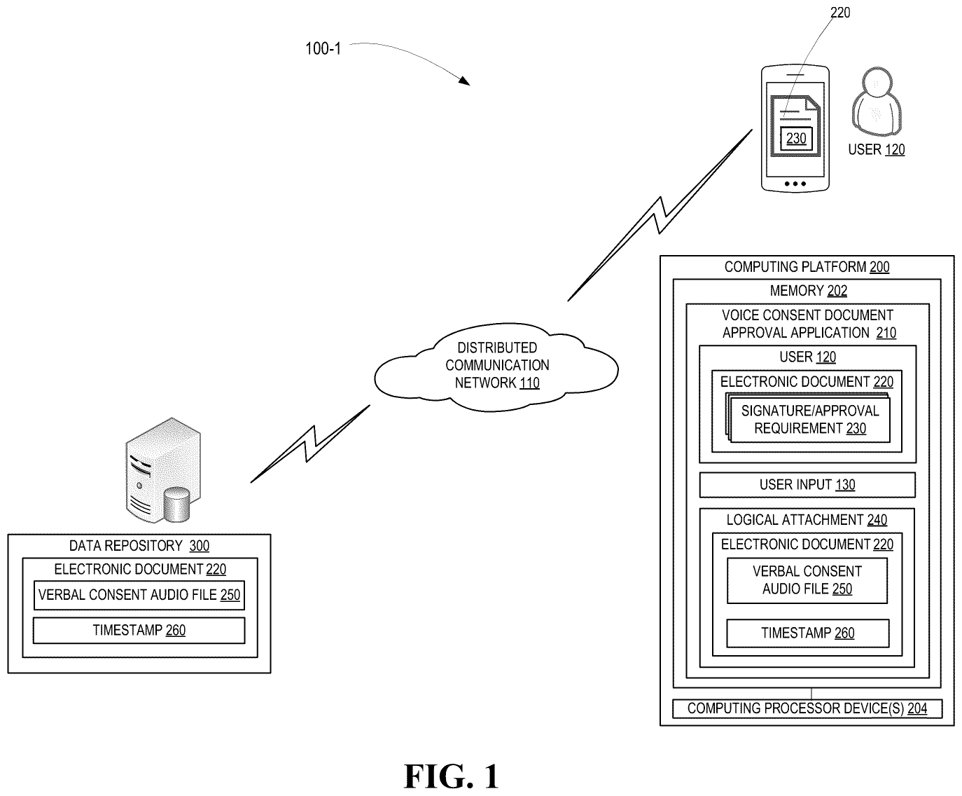

Referring to FIG. 1, a system 100-1 is depicted for digital approval of electronic documents, in accordance with embodiments of the present invention. “approval” as used herein means that a user, having comprehended the electronic document, approves of the contents therein, in some instances, the approval legally binds the user, such as, formation of a contract or the like. The system is implemented within a distributed communication network which may include the Internet, one or more intranets, one or more cellular networks and the like. The system additionally includes a computing platform 200, which, as depicted in FIG. 1, includes a user device, such as a mobile communication device. However, one of ordinary skill in the art will appreciate that computing platform 200 may include one or more network-based devices, such as an application server(s) or the like, or a combination of a user device and one or more network-based devices.

Computing platform 200 includes memory 202 and one or more computing processor devices 204 in communication with memory 202. Memory 202 may comprise volatile and non-volatile memory, such as read-only and/or random-access memory (RAM and ROM), EPROM, EEPROM, flash cards, or any memory common to computer platforms). Moreover, memory 202 may comprise cloud storage, such as provided by a cloud storage service and/or a cloud connection service. Computing processing device(s) 204 may be an application-specific integrated circuit (“ASIC”), or other chipset, logic circuit, or other data processing device. Computing processing device(s) 204 may execute an application programming interface (“API”) (not shown in FIG. 1) that interfaces with any resident instructions, such as voice consent document approval application 210 or an application associated therewith or the like stored in the memory 202 of the computing platform 200. Computing processing device(s) 204 may include various processing subsystems (not shown in FIG. 1) embodied in hardware, firmware, software, and combinations thereof, that enable the functionality of computing platform 200 and the operability of the computing platform 200 on a distributed communication network 110. For example, processing subsystems allow for initiating and maintaining communications and exchanging data with other networked devices. For the disclosed aspects, processing subsystems of computing processing device(s) 204 may include any subsystem used in conjunction with voice consent document approval application 210 and related sub-instructions, sub-routines, algorithms, sub-algorithms, modules, sub-modules thereof.

Memory 202 stores voice consent document approval application 210 that is executable by at least one of the one or more computing processor devices 204. In response to authenticating a user 120 (i.e., verifying the identity of user 120), voice consent document approval application 210 is configured to present the user 120 with an electronic document 220 having one or more signature requirements 230 for the user to approve the contents of the electronic document. The presentation may be in response to the user 120 uploading a document to the voice consent document approval application 210 or the user 120 requesting or consenting to presentation from a third-party document repository (e.g., financial institution or the like). According to embodiments of the invention, presentation may be visual (i.e., depicted on a display of the user device) or may be audible (i.e., read to the user).

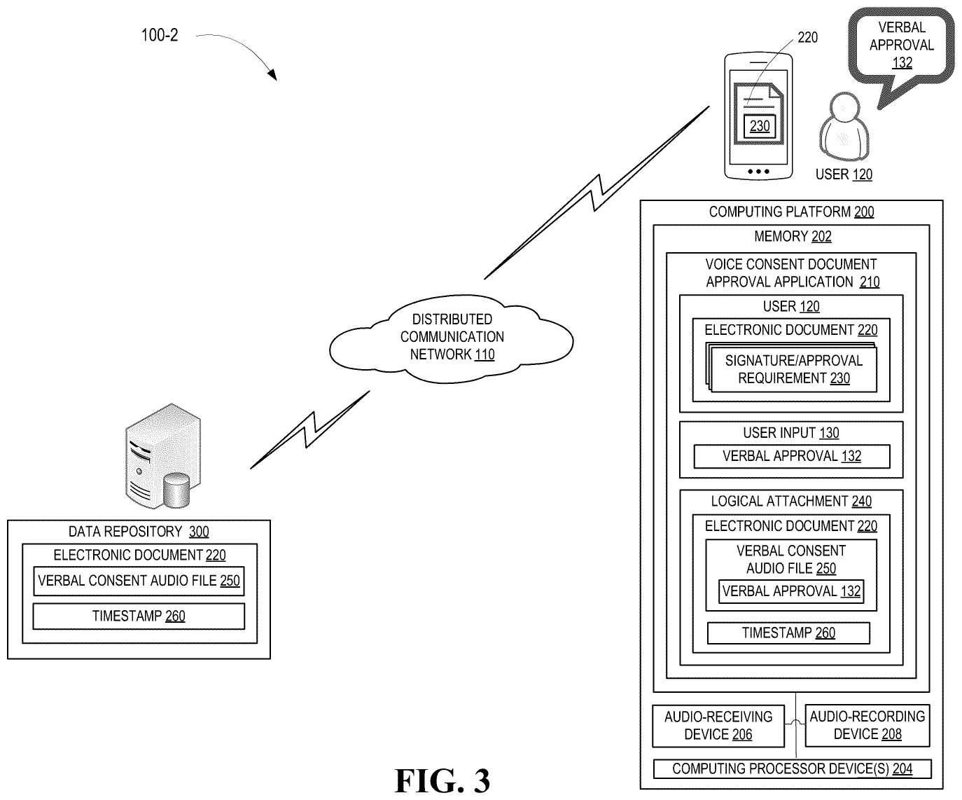

In response to presentation, voice consent document approval application 210 is configured to receive at least one input 130 from the user that is configured to approve the contents of the electronic document 220. As discussed in further embodiments of the invention, depicted in FIGS. 3, 5, 7, 9 and 11 input 130 may be a verbal input (i.e., spoken by the user 130) or a non-verbal input (i.e., activating a designated approval link displayed on the user device or the like. In response to receiving the at least one input 130, voice consent document approval application 210 is configured to logically attach 240 a verbal approval audio file 250 to the electronic document 220 and provide a timestamp 260 that indicates a date and a time of the logical attachment 240. In specific embodiments of the invention, logical attachment 240 may provide for applying one or more hash algorithms to the electronic document 220 and verbal consent audio file 250 to form an encrypted file comprising the electronic document 220 and verbal consent audio file 250.

System 100-1 additionally includes a data repository 300 which is configured to receive and store the electronic document 220 with the logically attached verbal consent audio 250 and timestamp 260. Storing of the electronic document 220 with the logically attached verbal consent audio 250 and timestamp 260 provides for auditable defense that the user has, in fact, agreed to the contents of the electronic document 220 and satisfied the signature requirements 230.

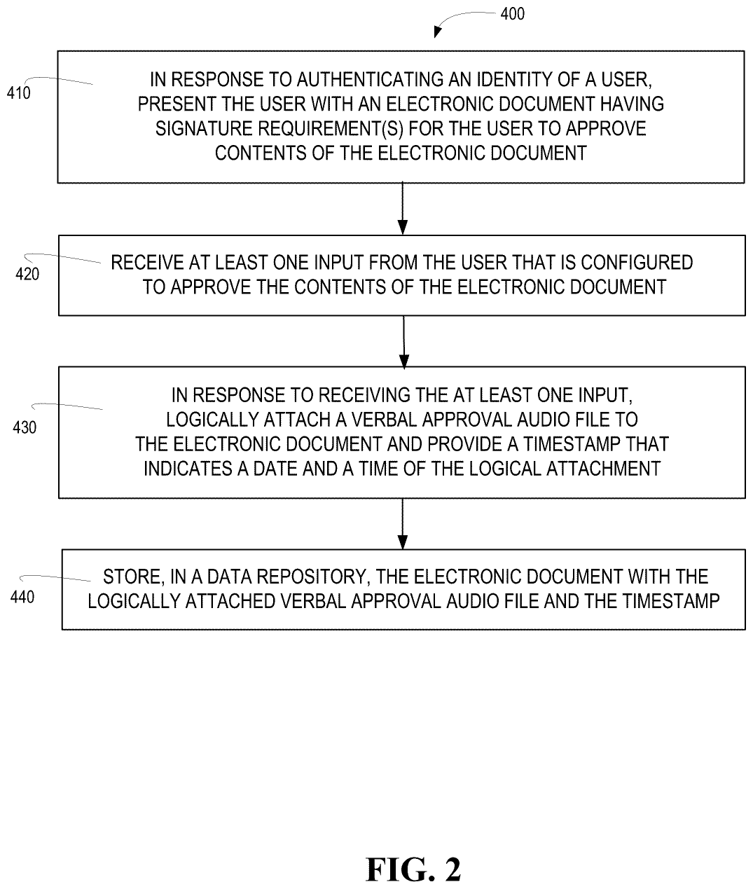

Referring to FIG. 2 a flow diagram of a method 400 for digital approval of electronic documents, in accordance with embodiments of the present invention. Method 400 is consistent with the system 100-1 shown in FIG. 1. In response to authenticating an identity of a user, at Event 410, the user is presented (visually or audibly) with an electronic document that has one or more signature requirement(s) for the user to execute as a means of approving the electronic document.

In response to presenting the electronic document, at Event 420, one or more inputs are received from the user that are configured to approve the contents of the electronic document or otherwise result in binding the user to the contents of the electronic document. As previously mentioned, and as discussed at length below, the input may be a verbal input or, in other embodiments of the invention, a non-verbal input.

In response to receiving the input(s), at Event 430, a verbal approval audio file is logically attached to the electronic document and a timestamp is provided that indicates a date and time of the logical attachment (i.e., date and time of the user approval). In specific embodiments of the method, logical attachment may be performed by applying one or more hash algorithms to the audio file and documents to create an encrypted file.

At Event 440, the electronic document with the logically attached verbal approval audio file and timestamp is stored in a data repository. The data repository may be a third-party data repository, such as a financial institution's data repository or a user data repository.

Referring to FIG. 3, a system 100-2 is depicted for digital approval of electronic diagrams, in accordance with embodiments of the present invention. The system 100-2 specifies that the input 130 received by the user 132 to approve the contents of the electronic document is a verbal approval 132 and that the verbal approval 132 forms the verbal consent audio file 250. As such, computing platform 200 is configured with an audio-receiving device 206, such as a microphone for receiving the verbal approval 132 and an audio-recording device 208 for capturing the verbal approval (i.e., recording the verbal consent audio file). The contents of the verbal approval may vary based on approval requirements for the specific document. At a minimum the verbal approval may include the name of the user and an approval statement (e.g., “I approve this document”). According to embodiments specific to system 100-2, since the verbal consent audio file 250 is formed from the user's verbal approval 132 provided concurrent with electronic document presentation, the verbal consent audio file 250 may additionally include information that is electronic-document specific, such as, but not limited to, the title of the electronic document or, where applicable, a specific document identifier/number, which may be user-specific. Additionally, verbal approve 132 may include the date on which the user 120 provides the verbal approval 132.

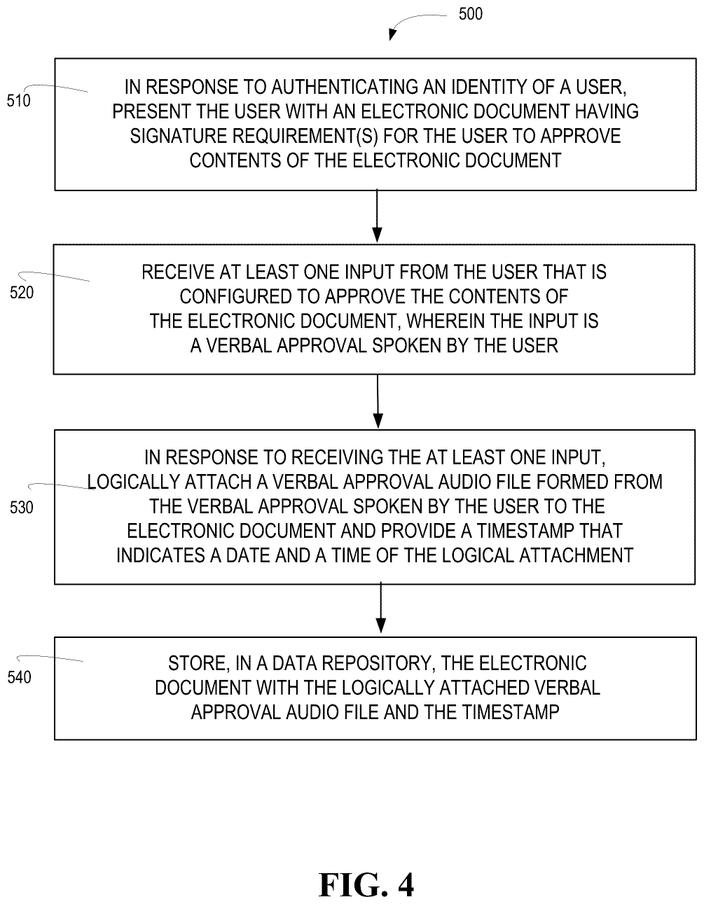

Referring to FIG. 4 a flow diagram of a method 500 for digital approval of electronic documents, in accordance with embodiments of the present invention. Method 500 is consistent with the system 100-2 shown in FIG. 3. In response to authenticating an identity of a user, at Event 510, the user is presented (visually or audibly) with an electronic document that has one or more signature requirement(s) for the user to execute as a means of approving the electronic document.

In response to presenting the electronic document, at Event 520, one or more inputs are received from the user that are configured to approve the contents of the electronic document or otherwise result in binding the user to the contents of the electronic document. The input is verbal approval spoken by the user.

In response to receiving the input(s), at Event 530, a verbal approval audio file formed from the verbal approval spoken by the user (i.e., the recorded audio of the verbal approval) is logically attached to the electronic document and a timestamp is provided that indicates a date and time of the logical attachment (i.e., date and time of the user approval). In specific embodiments of the method, logical attachment may be performed by applying one or more hash algorithms to the audio file and documents to create an encrypted file.

At Event 540, the electronic document with the logically attached verbal approval audio file and timestamp is stored in a data repository. The data repository may be a third-party data repository, such as a financial institution's data repository or a user data repository.

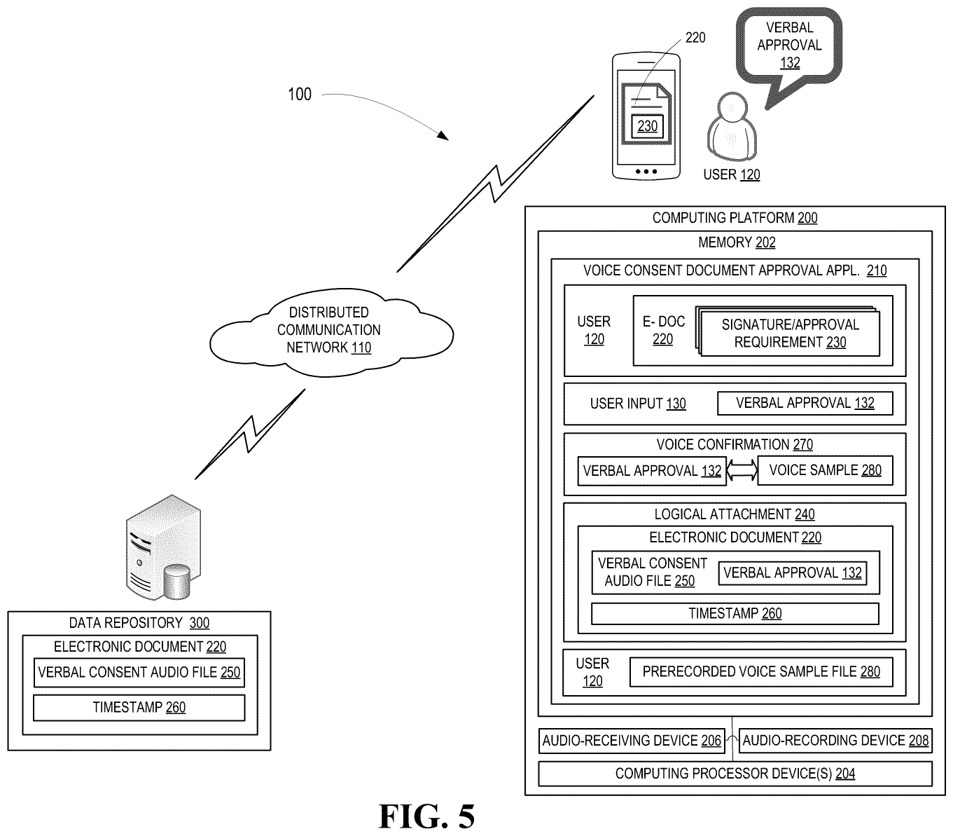

Referring to FIG. 5, a system 100-3 is depicted for digital approval of electronic diagrams, in accordance with embodiments of the present invention. System 100-3 is consistent with system 100-2 shown and discussed in relation to FIG. 3, in that, the input 130 received from the user 120 is verbal approval 132 and the verbal consent audio file 250 is formed from the verbal approval 132. In addition, system 100-3 provides for voice consent document approval application 210 to be configured to perform a voice confirmation 270 is response to receiving the input 130 (i.e., verbal approval 132). In this regard, voice consent document approval application 210 to be configured to compare the recorded verbal approval 132 to a prerecorded voice sample 280 audio file associated with the user 120 (i.e., a voice sample 280 that has previously been confirmed as being the user's voice) to confirm that the verbal approval 132 was, in fact, spoken by the user 120. In response to confirming that the verbal approval 132 was spoken by the user 130, voice consent document approval application 210 then proceeds with logically attaching 240 the verbal approval audio file 250 to the electronic document 220 and provide the timestamp 260 that indicates the date and the time of the logical attachment 240. In the even that voice consent document approval application 210 is unable to confirm that the verbal approval 132 was spoken by the user 130, voice consent document approval application 210 is configured to request that the user provide additional verbal approval, some other form of approval (e.g., e-signature) or, in certain instances, forbid the user for approving the contents of the electronic document 220.

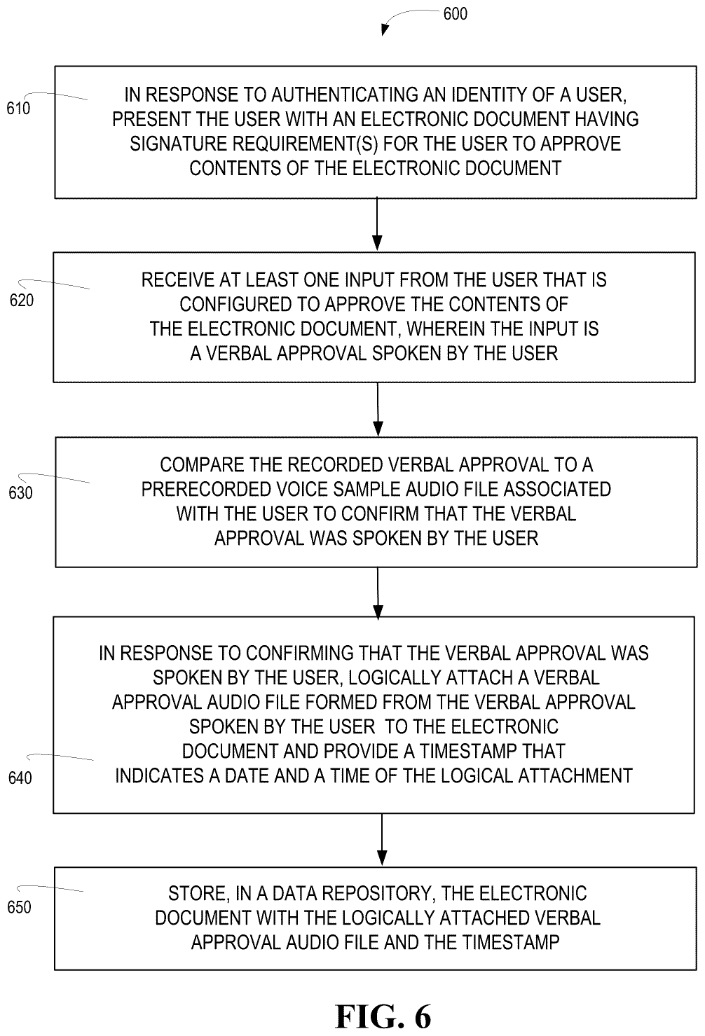

Referring to FIG. 6 a flow diagram of a method 600 for digital approval of electronic documents, in accordance with embodiments of the present invention. Method 600 is consistent with the system 100-3 shown in FIG. 5. In response to authenticating an identity of a user, at Event 610, the user is presented (visually or audibly) with an electronic document that has one or more signature requirement(s) for the user to execute as a means of approving the electronic document.

In response to presenting the electronic document, at Event 620, one or more inputs are received from the user that are configured to approve the contents of the electronic document or otherwise result in binding the user to the contents of the electronic document. The input is verbal approval spoken by the user.

At Event 630 the recorded verbal approval is compared to a prerecorded voice sample associated with the user (i.e., a voice sample verified as belonging to the user) to confirm that the verbal approval was, in fact, spoken by the user.

In response to confirming that the verbal approval was spoken by the user, at Event 640, a verbal approval audio file formed from the verbal approval spoken by the user (i.e., the recorded audio of the verbal approval) is logically attached to the electronic document and a timestamp is provided that indicates a date and time of the logical attachment (i.e., date and time of the user approval). In specific embodiments of the method, logical attachment may be performed by applying one or more hash algorithms to the audio file and documents to create an encrypted file.

At Event 650, the electronic document with the logically attached verbal approval audio file and timestamp is stored in a data repository. The data repository may be a third-party data repository, such as a financial institution's data repository or a user data repository

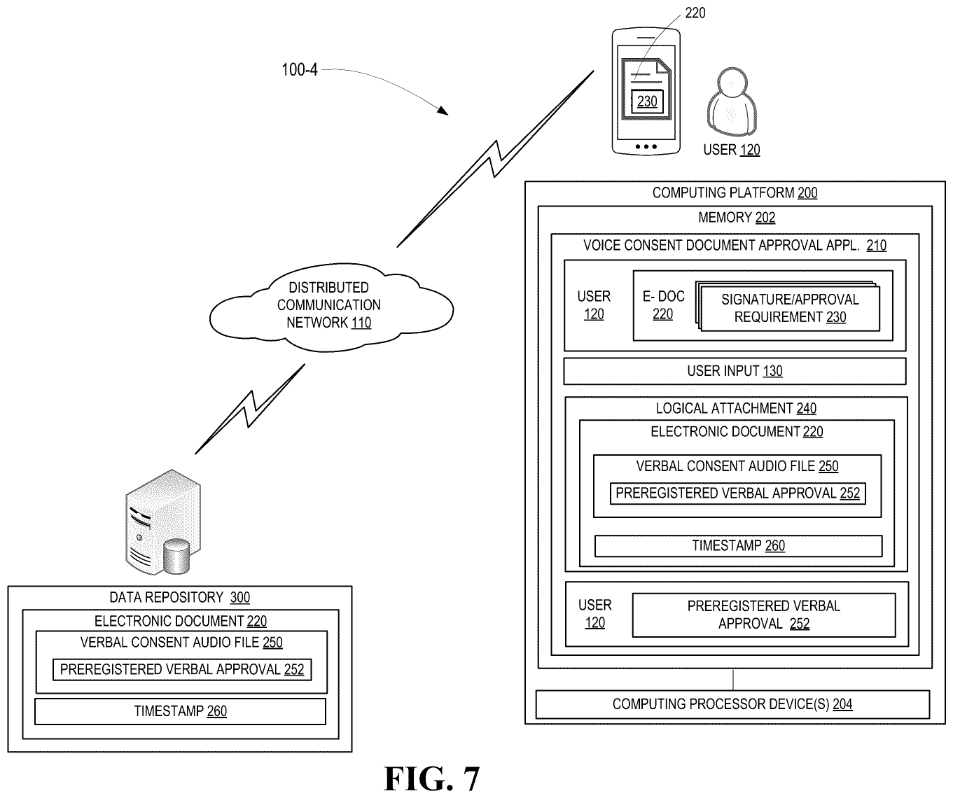

Referring to FIG. 7, a system 100-4 is depicted for digital approval of electronic diagrams, in accordance with embodiments of the present invention. The system 100-4 specifies that the verbal consent audio file 250 is formed from a preregistered verbal approval 252 (i.e., a verbal approval that the user 120 has “on-file”). The preregistered verbal approval 252 includes a generic statement from the user that includes the user's name and an approval statement (“I approve this document”) and has been verified as having been spoken by the user. In such embodiments of the invention, since the verbal approval has been preregistered and is on-file, user input 130 may be, but is not required to be, a non-verbal input, such as activation of an approval link/URL or the like.

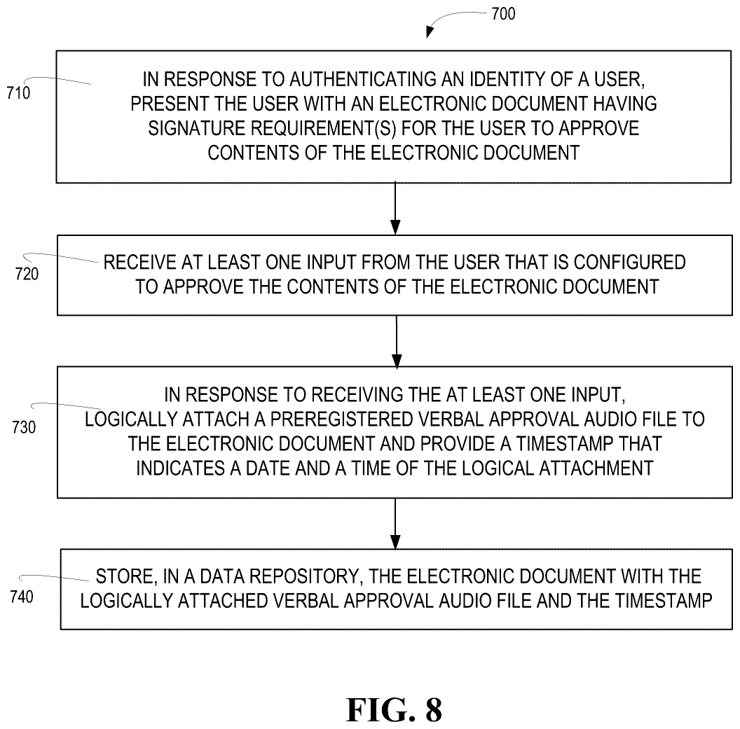

Referring to FIG. 8 a flow diagram of a method 700 for digital approval of electronic documents, in accordance with embodiments of the present invention. Method 700 is consistent with the system 100-4 shown in FIG. 7. In response to authenticating an identity of a user, at Event 710, the user is presented (visually or audibly) with an electronic document that has one or more signature requirement(s) for the user to execute as a means of approving the electronic document.

In response to presenting the electronic document, at Event 720, one or more inputs are received from the user that are configured to approve the contents of the electronic document or otherwise result in binding the user to the contents of the electronic document. The input may be a non-verbal input (i.e., activation of input device/mechanism, such as a link/URL or the like) or, in other embodiments, the input may be a verbal input/approval spoken by the user.

In response to receiving the input(s), at Event 730, a verbal approval audio file containing the user's preregistered verbal approval (i.e., a verbal approval audio file that is “on-file) is logically attached to the electronic document and a timestamp is provided that indicates a date and time of the logical attachment (i.e., date and time of the user approval). In specific embodiments of the method, logical attachment may be performed by applying one or more hash algorithms to the audio file and documents to create an encrypted file.

At Event 740, the electronic document with the logically attached verbal approval audio file containing the user's preregistered verbal approval and timestamp is stored in a data repository. The data repository may be a third-party data repository, such as a financial institution's data repository or a user data repository.

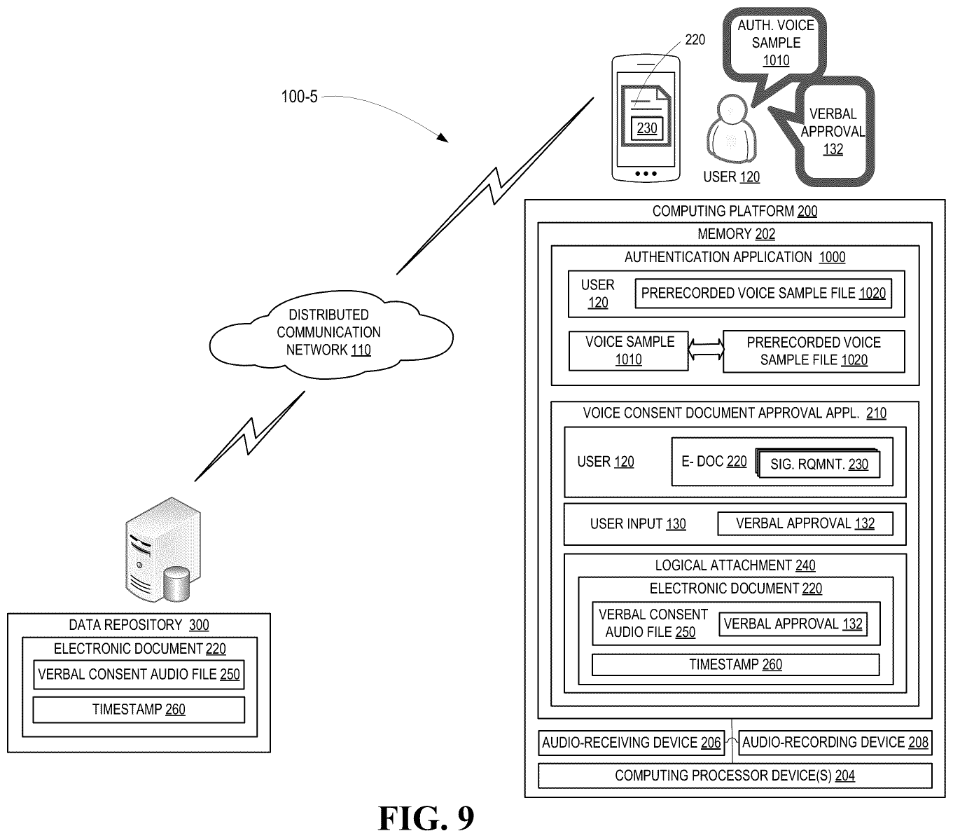

Referring to FIG. 9, a system 100-5 is depicted for digital approval of electronic diagrams, in accordance with embodiments of the present invention. Computing platform 200 includes an audio-receiving device 206, such as a microphone or the like and an audio recording device 208 that are both in communication with computing processor device(s) 204. Memory 202 of computing platform 200 stores authentication application 1000 that is configured to receive, via audio-receiving device 206, and record, via audio-recording device 208, a voice sample 1010 from user 120 and compare the voice sample 1010 to a prerecorded voice sample audio file 410 associated with the user to authenticate the identity of the user 120. Prerecorded voice sample audio file 410 has been previously verified as being the voice of the user 120.

In response to verifying the authenticity of the user 120 via the aforementioned voice sample 1010, voice consent document approval application 210 is configured to present the user 120 with an electronic document 220 having one or more signature requirements 230 for the user to approve the contents of the electronic document and, in response to presentation, receive one or more user input(s) 130 that comprises a verbal approval 132 spoken by the user 120. Since the authorization application 400 has already verified that the voice sample 1010 belongs to the user 120, such information is passed along to the voice consent document approval application 210 which, in specific embodiments of the invention, may be configured to forego a separate process of verifying that the verbal approval 132 belongs to the user 120 and rely solely on the voice sample 1010 verification of the authentication application. Such embodiments of the invention rely on the assumption that the user that has been authenticated via the voice sample 1010 is the same user inputting the verbal approval 132.

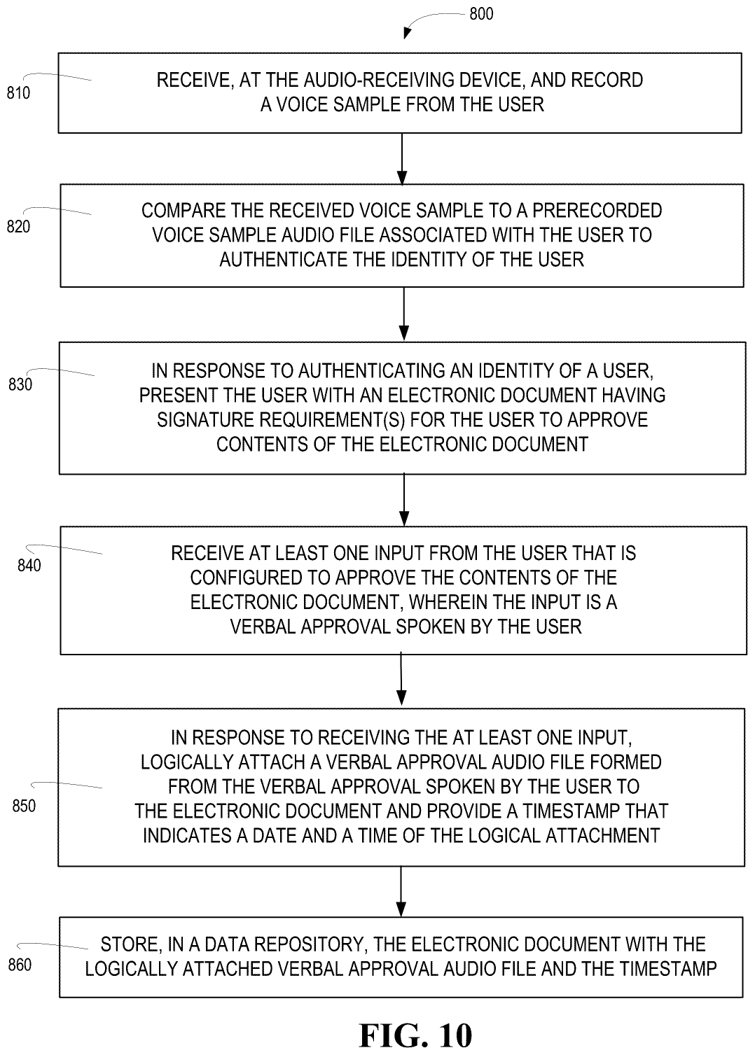

Referring to FIG. 10 a flow diagram of a method 800 for digital approval of electronic documents, in accordance with embodiments of the present invention. Method 800 is consistent with the system 100-5 shown in FIG. 9. At Event 810, a voice sample is received from a user and, at Event 820, the voice sample is compared to a prerecorded voice sample associated with the user to authenticate the identity of the user.

In response to authenticating an identity of a user, at Event 830, the user is presented (visually or audibly) with an electronic document that has one or more signature requirement(s) for the user to execute as a means of approving the electronic document.

In response to presenting the electronic document, at Event 840, one or more inputs are received from the user that are configured to approve the contents of the electronic document or otherwise result in binding the user to the contents of the electronic document. The input is verbal approval spoken by the user.

In response to receiving the input(s), at Event 850, a verbal approval audio file formed from the verbal approval spoken by the user (i.e., the recorded audio of the verbal approval) is logically attached to the electronic document and a timestamp is provided that indicates a date and time of the logical attachment (i.e., date and time of the user approval). In specific embodiments of the method, logical attachment may be performed by applying one or more hash algorithms to the audio file and documents to create an encrypted file. The method may rely on the voice sample being authenticated as a means for foregoing a separate verification process that would otherwise verify that the verbal approval has been spoken by the user.

At Event 860, the electronic document with the logically attached verbal approval audio file and timestamp is stored in a data repository. The data repository may be a third-party data repository, such as a financial institution's data repository or a user data repository.

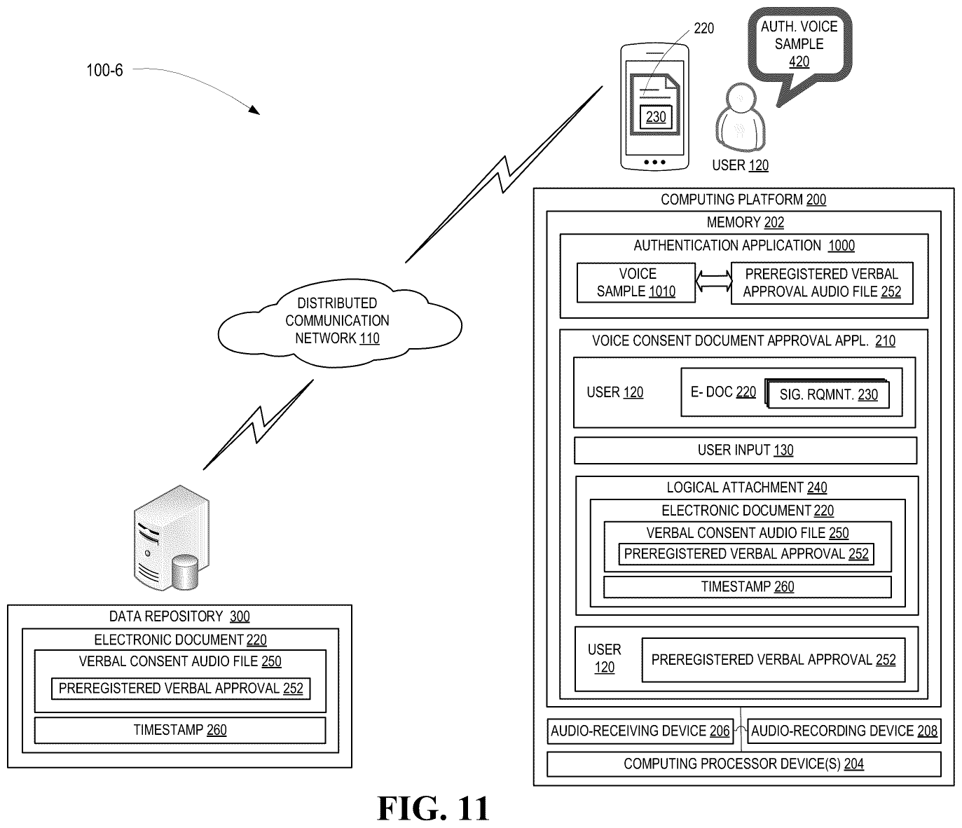

Referring to FIG. 11, a system 100-6 is depicted for digital approval of electronic diagrams, in accordance with embodiments of the present invention. Similar to the computing platform 200 shown and described in relation to FIG. 9, computing platform 200 includes an audio-receiving device 206, such as a microphone or the like and an audio recording device 208 that are both in communication with computing processor device(s) 204. Memory 202 of computing platform 200 stores authentication application 1000 that is configured to receive, via audio-receiving device 206, and record, via audio-recording device 208, a voice sample 1010 from user 120 and compare the voice sample 1010 to a preregistered verbal approval 252 audio file that forms the preregistered verbal consent audio file 250 to authenticate the identity of the user 120. Preregistered voice approval 252 audio file has been previously verified as being the voice of the user 120.

In response to verifying the authenticity of the user 120 via the aforementioned voice sample 1010, voice consent document approval application 210 is configured to present the user 120 with an electronic document 220 having one or more signature requirements 230 for the user to approve the contents of the electronic document and, in response to presentation, receive one or more user input(s) 130, which may be non-verbal inputs. In response to receiving the input(s) 130, voice consent document approval application 210 is configured to logically attach the electronic document to the verbal approval audio file 250, which comprises the preregistered verbal approval 252 audio file that was used to authenticate the user.

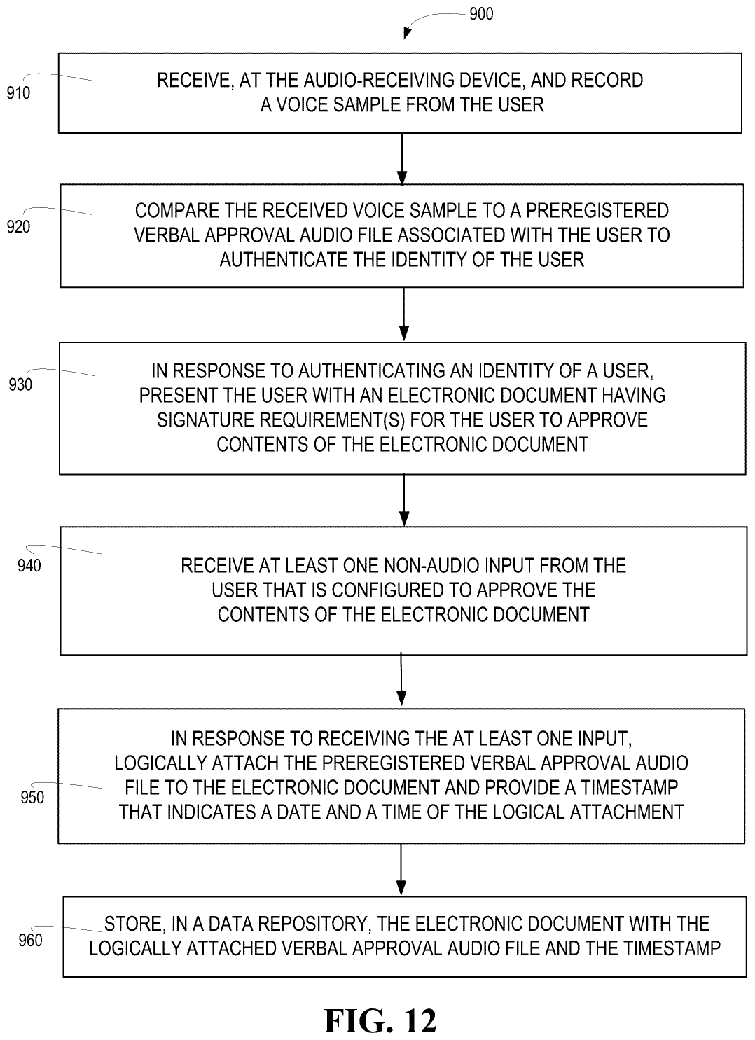

Referring to FIG. 12 a flow diagram of a method 900 for digital approval of electronic documents, in accordance with embodiments of the present invention. Method 900 is consistent with the system 100-6 shown in FIG. 11. At Event 910, a voice sample is received from a user and, at Event 920, the voice sample is compared to a preregistered verbal approval audio file associated with the user (i.e., pre-verified as being the voice of the user) to verify the identity of the user.

In response to authenticating an identity of a user, at Event 930, the user is presented (visually or audibly) with an electronic document that has one or more signature requirement(s) for the user to execute as a means of approving the electronic document.

In response to presenting the electronic document, at Event 940, one or more inputs are received from the user that are configured to approve the contents of the electronic document or otherwise result in binding the user to the contents of the electronic document. The input may be non-verbal or verbal.

In response to receiving the input(s), at Event 950, a verbal approval audio file formed from preregistered verbal approval audio file is logically attached to the electronic document and a timestamp is provided that indicates a date and time of the logical attachment (i.e., date and time of the user approval). In specific embodiments of the method, logical attachment may be performed by applying one or more hash algorithms to the audio file and documents to create an encrypted file.

At Event 960, the electronic document with the logically attached verbal approval audio file and timestamp is stored in a data repository. The data repository may be a third-party data repository, such as a financial institution's data repository or a user data repository.

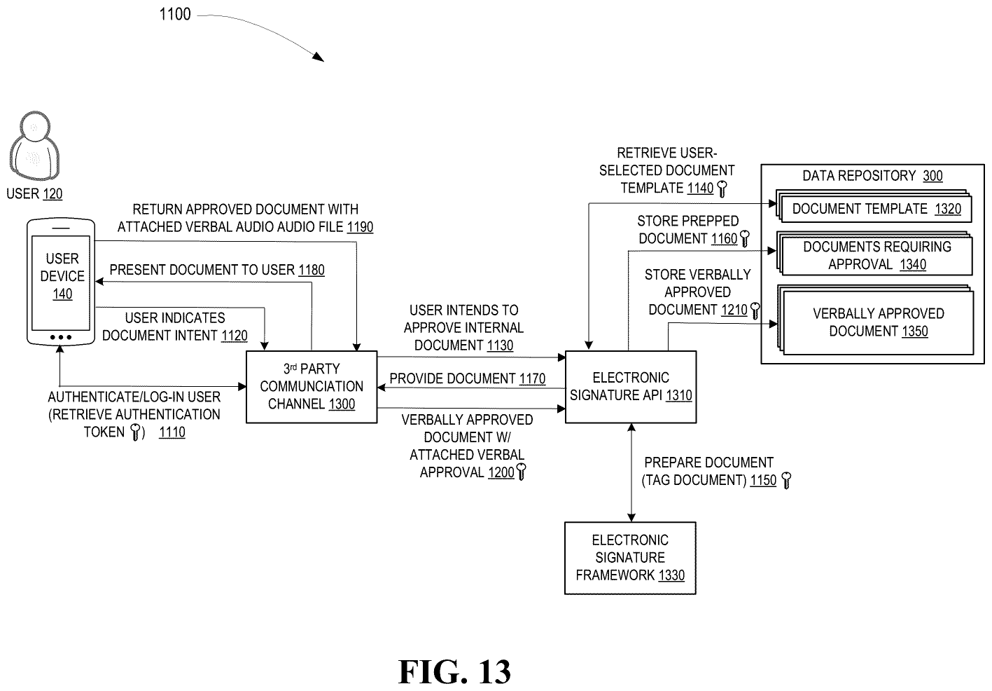

Referring to FIG. 13 a block/flow diagram is presented that illustrates a methodology 1100 for third-party presentation of an electronic document requiring approval and subsequent storage of the approved document and attached verbal approval audio file, in accordance with embodiments of the present invention. At Event 1110, user 120 implements user device 140 to authenticate (i.e., login into) at a third-party communication channel 1300. For example, the third-party may be a financial institution or government agency and the communication channel 1300 may be a website (e.g., online banking), an application (e.g., mobile banking application) or the like. In response to authentication, user 120 is presented an authentication key/token which serves as the gateway for gaining access to other network-based, third-party controlled entities/services. As previously discussed, in specific embodiments of the invention user authentication occurs verbally (i.e., using voice recognition techniques), while in other embodiments of the invention, any known or future known means of authentication may occur, such as, but not limited to, presentation of username/passcode, capture and comparison of personal data (e.g., fingerprints, facial image or the like) and the like.

At Event 1120, the user 1120 via user device 140 is provided options for digital approval of electronic documents. The options may include, but are not limited to, approving an internal (i.e., third-party provided) document, notarization of an internal (i.e., third-party provided) document, providing (i.e., uploading) and approving a user-supplied document or the like. In accordance with the embodiments shown and discussed in relation to FIG. 13, the user's indicated document intent (i.e., selected option) is to approve a selected internal (i.e., third-party provided) document. Documents requiring user approval may exist in a user repository/digital locker and the user may be notified of such documents in response to logging into/authenticating at the third-party communication channel 1300.

At Event 1130, the third-party communication channel 1300 calls the electronic signature (e-signature) Application Programming Interface (API) 1310 and notifies the e-signature API 1310 that the user intends to approve an internal electronic document and provides identification of the electronic document. At Event 1140, the e-signature API 1310 calls the data repository 300 and retrieves the document template 1320 associated with the user-selected document. At Event 1150, the e-signature API provides the document template 1320 to the electronic signature framework 1330 for document preparation. Document preparation includes tagging the document to indicate to the user where approval is required within the document. In response to document preparation, at Event 1160, e-signature API 1310 calls the data repository 320 and stores the prepared document as a document requiring approval 1340 (i.e., yet-to-be approved).

Concurrent with the storage of the document requiring approval, at Event 1170, the e-signature API 1310 provides the electronic document to the third-party communication channel, which, at Event 1180, presents the document to the user 120 via the user device 140. As previously discussed, presentation may be visual (on the display of user device 140) or audible (via microphone of user device 140). In accordance with embodiments of the invention, a user input is received, which, in specific embodiments is a verbal consent, while in other embodiments of the invention, such as, but not limited to, when the verbal consent is a generic preregistered verbal consent stored by the third-party, the input may be non-verbal (e.g., activating a displayed link/URL or the like). In response to receiving the user input, an application residing on the user device and/or executed by third-party (i.e., network-based) logically attaches a verbal approval audio file to the electronic document and adds a timestamp. In alternate embodiments of the invention, an e-signature of the user, stored and retrieved by the third-party, may also be logically attached to the electronic document.

Subsequently, at Event 1190, the user device 1190 returns an approved document with an attached verbal approval audio file and timestamp to the third-party communication channel 1300, which, in turn, at Event 1200, forwards the approved document with an attached verbal approval audio file and timestamp to the e-signature API 1310. At Event 1210, the e-signature API 1310 calls out the data repository 300 and stores the approved document with an attached verbal approval audio file and timestamp therein as a verbally approved document 1350. Storage of the e-document along with the verbal approve serves as verifiable proof (for evidentiary purposes and the like) that the user has approved the contents and/or agreed to be legally bound to the contents of the electronic document.

Thus, present embodiments of the invention provide systems, methods, computer program products and/or the like for digital approval of electronic documents via a user's recorded verbal consent. In this regard, verbal consent provided by a user is captured in an audio file, either concurrent with document presentation or prerecorded/preregistered, and, in response to the user providing an input that approves the electronic document, the verbal consent audio file is logically attached to the document to serve as a valid signature (i.e., approval/acceptance of the documents content). The verbal consent audio file, along with a timestamp, is stored in conjunction with the document and can subsequently be used for evidentiary purposes in proving the validity of the user's approval.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for digital approval of electronic documents, the system comprising:
a computing platform including a memory and at one or more first processor devices in communication with the memory, wherein the memory stores a voice consent document approval application, executable by at least one of the one or more first processor devices and configured to:
in response to authenticating an identity of a user, present the user with an electronic document having one or more signature requirements for the user to approve contents of the electronic document,
receive at least one input from the user that is configured to approve the contents of the electronic document, and
in response to receiving the at least one input, logically attach a verbal approval audio file to the electronic document and provide a timestamp that indicates a date and a time of the logical attachment; and
a data repository configured to receive and store the electronic document with the logically attached verbal approval audio file and the timestamp.

2. The system of claim 1, wherein computing platform further comprises (i) an audio-receiving device in communication with at least one of the one or more first processor devices and (ii) an audio-recording mechanism in communication with the audio-receiving device and at least one of the one or more first processor devices,
wherein the voice consent document approval application is further configured to receive the input, wherein the input comprises verbal approval spoken by the user received by the audio-receiving device and recorded by the audio-recording mechanism to form the verbal approval audio file.

3. The system of claim 2, wherein the voice consent document approval application is further configured to:
compare the recorded verbal approval to a prerecorded voice sample audio file associated with the user to confirm that the verbal approval was spoken by the user, and
in response to confirming that the verbal approval was spoken by the user, logically attach the verbal approval audio file to the electronic document and provide the timestamp that indicates the date and the time of the logical attachment.

4. The system of claim 1, wherein the voice consent document approval application is further configured to:
logically attach the verbal approval audio file to the electronic document, wherein the verbal approval audio file is a preregistered verbal approval audio file, wherein preregistration provides for verification that the user has spoken or authorized the verbal approval in the audio file.

5. The system of claim 1, wherein computing platform further comprises an audio-receiving device in communication with at least one of the one or more first processor devices and an audio-recording mechanism in communication with the audio-receiving device and at least one of the one or more first processor devices, and wherein the memory of the computing platform further comprises an authentication application, executable by at least one of the one or more first processor devices and configured to:
receive, at the audio-receiving device, and record, with the audio-recording mechanism, a voice sample from the user, and
compare the received voice sample to a prerecorded voice sample audio file associated with the user to authenticate the identity of the user.

6. The system of claim 5, wherein the voice consent document approval application is further configured to:
receive the at least one input from the user that is configured to approve the contents of the electronic document, wherein the at least one input is a non-verbal input,
logically attach the verbal approval audio file to the electronic document, wherein the verbal approval audio file is a preregistered verbal approval audio file, wherein preregistration provides for verification that the user has spoken or authorized the verbal approval in the audio file.

7. The system of claim 1, wherein the voice consent document approval application is further configured to:
input a preregistered electronic signature associated with the user in one or more signature entry fields within the electronic document, wherein preregistration provides for verification that the electronic signature is associated with the user, and
logically attach the preregistered electronic signature to the electronic document.

8. A computer-implemented method for digital approval of electronic documents, the method is executed by one or more processing devices and comprises:
in response to authenticating an identity of a user, presenting the user with an electronic document having one or more signature requirements for the user to approve contents of the electronic document;
receiving at least one input from the user that is configured to approve the contents of the electronic document;
logically attaching the verbal approval audio file to the electronic document and providing a timestamp that indicates a date and a time of the logical attachment; and
storing, in a data repository, the electronic document with the logically attached verbal approval audio file and the timestamp.

9. The computer-implemented method of claim 8, wherein receiving the at least one input further comprises receiving the at least one input comprising a verbal approval spoken by the user, and wherein the method further includes recording the verbal approval to form the verbal approval audio file.

10. The computer-implemented method of claim 9, further comprising:
comparing the recorded verbal approval to a prerecorded voice sample audio file associated with the user to confirm that the verbal approval was spoken by the user; and
in response to confirming that the verbal approval was spoken by the user, logically attaching the verbal approval audio file to the electronic document and provide the timestamp that indicates the date and the time of the logical attachment.

11. The computer-implemented method of claim 8, wherein logically attaching the verbal approval audio file to the electronic document further comprises logically attaching a preregistered verbal approval audio file to the electronic document, wherein preregistration provides for verification that the user has spoken or authorized the verbal approval in the audio file.

12. The computer-implemented method of claim 8, further comprising:
receiving and recording a voice sample from the user; and
comparing the received voice sample to a prerecorded voice sample audio file associated with the user to authenticate the identity of the user.

13. The computer-implemented method of claim 12, wherein receiving at least one input from the user that is configured to approve the contents of the electronic document further comprises receiving a non-verbal input to approve the contents of the electronic document, and wherein logically attaching the verbal approval audio file to the electronic document further comprises logically attaching a preregistered verbal approval audio file to the electronic document, wherein preregistration provides for verification that the user has spoken or authorized the verbal approval in the audio file.

14. The computer-implemented method of claim 8, further comprising:
inputting a preregistered electronic signature associated with the user in one or more signature entry fields within the electronic document, wherein preregistration provides for verification that the electronic signature is associated with the user, and
logically attaching the preregistered electronic signature to the electronic document.

15. A computer program product comprising:
a non-transitory computer-readable medium comprising:
a first set of codes for causing a computer processing device to, in response to authenticating an identity of a user, present the user with an electronic document having one or more signature requirements for the user to approve contents of the electronic document;
a second set of codes for causing a computer processing device to receive at least one input from the user that is configured to approve the contents of the electronic document;
a third set of codes for causing a computer processing device logically attach the verbal approval audio file to the electronic document and providing a timestamp that indicates a date and a time of the logical attachment; and
a fourth set of codes to store, in a data repository, the electronic document with the logically attached verbal approval audio file and the timestamp.

16. The computer program product of claim 15, wherein the second set of codes are further configured to cause the computer processing device to receive the at least one input comprising a verbal approval spoken by the user, and wherein the computer-readable medium further comprises a fifth set of codes for causing a computer processing device to record the verbal approval to form the verbal approval audio file.

17. The computer program product of claim 16, wherein the computer-readable medium further comprises:
a fifth set of codes for causing a computer processing device to compare the recorded verbal approval to a prerecorded voice sample audio file associated with the user to confirm that the verbal approval was spoken by the user; and
a sixth set of codes for causing a computer processing device to, in response to confirming that the verbal approval was spoken by the user, logically attach the verbal approval audio file to the electronic document and provide the timestamp that indicates the date and the time of the logical attachment.

18. The computer program product of claim 15, wherein the third set of codes are further configured to cause the computer processing device to logically attach a preregistered verbal approval audio file to the electronic document, wherein preregistration provides for verification that the user has spoken or authorized the verbal approval in the audio file.

19. The computer program product of claim 15, wherein the computer-readable medium further comprises:
a fifth set of codes for causing a computer processing device to receive and record a voice sample from the user; and
a sixth set of codes for causing a computer processing device to compare the received voice sample to a prerecorded voice sample audio file associated with the user to authenticate the identity of the user.

20. The computer-implemented method of claim 19, wherein the third set of codes are further configured to cause the computing processing device to logically attach a preregistered verbal approval audio file to the electronic document, wherein preregistration provides for verification that the user has spoken or authorized the verbal approval in the audio file.
